(19) United States
(12) Patent Application Publication
(10) Pub. No.: US 2017/0189965 A1
(43) Pub. Date: Jul. 6, 2017

(54) MATERIALS AND FORMULATIONS FOR THREE-DIMENSIONAL PRINTING

(71) Applicant: Applied Materials, Inc., Santa Clara, CA (US)

(72) Inventors: Kaushik VAIDYA, Bangalore (IN); Simon YAVELBERG, Cupertino, CA (US); Cariappa Achappa BADUVAMANDA, Bangalore (IN)

(21) Appl. No.: 15/398,787

(22) Filed: Jan. 5, 2017

Related U.S. Application Data
(60) Provisional application No. 62/275,035, filed on Jan. 5, 2016.

(51) Int. Cl. B22F 7/00; B28B 1/00; B33Y 10/00; B23K 26/00; B33Y 70/00; B22F 3/105; B23K 26/342; B23K 26/70; B29C 67/00; B33Y 50/02

(52) U.S. Cl. CPC B22F 7/008; B29C 67/0077; B29C 67/0088; B28B 1/001; B33Y 10/00; B33Y 50/02; B33Y 70/00; B22F 3/1055; B23K 26/342; B23K 26/70; B23K 26/0006; B29K 2105/251

(57) ABSTRACT

Implementations described herein generally relate to additive manufacturing. More particularly, implementations disclosed herein relate to formulations and processes for forming articles via a three-dimensional printing (or 3D printing) process. In one implementation, a method of additive manufacturing is provided. The method comprises dispensing a first layer of a feed material over a platen. The feed material includes a powder mixture comprising a plurality of particulates comprising a first material and a plurality of particulates comprising a second material different from the first material. The method further comprises directing a laser beam to heat the feed material at locations specified by data stored in a computer readable medium. The laser beam heats the feed material to a temperature sufficient to fuse at least the second material.

### CROSS-REFERENCE TO RELATED APPLICATIONS

This application claims benefit of U.S. Provisional Patent Application Ser. No. 62/275,035, filed Jan. 5, 2016, which is incorporated herein by reference in its entirety.

### BACKGROUND

Field

Implementations described herein generally relate to additive manufacturing. More particularly, implementations disclosed herein relate to formulations and processes for forming articles via a three-dimensional printing (or 3D printing) process.

Description of the Related Art

Additive manufacturing (AM), also known as solid freeform fabrication or 3D printing, refers to any manufacturing process where three-dimensional objects are built-up from raw material (generally powders, liquids, suspensions, or molten solids) in a series of two-dimensional layers or cross-sections. In contrast, traditional machining techniques involve subtractive processes and produce objects cut out of a stock material such as a block of wood or metal.

A variety of additive processes can be used in additive manufacturing. The various processes differ in the way layers are deposited to create the finished objects and in the materials that are compatible for use in each process. Some methods melt or soften material to produce layers, for example, selective laser melting (SLM) or direct metal laser sintering (DMLS), selective laser sintering (SLS), fused deposition modeling (FDM), while others cure liquid materials using different technologies, e.g., stereolithography (SLA).

Sintering is a process of fusing small grains, for example, powders, to create objects. Sintering usually involves heating a powder. When a powdered material is heated to a sufficient temperature in a sintering process, the atoms in the powder particles diffuse across the boundaries of the particles, fusing the particles together to form a solid piece. In contrast to melting, the powder used in sintering need not reach a liquid phase as the sintering temperature does not have to reach the melting point of the material, sintering is often used for materials with high melting points such as tungsten and molybdenum.

Both sintering and melting can be used in additive manufacturing. Selective laser melting (SLM) is used for additive manufacturing of metals or metal alloys, which have a discrete melting temperature and undergo melting during the SLM process.

### SUMMARY

Implementations described herein generally relate to additive manufacturing. More particularly, implementations disclosed herein relate to formulations and processes for forming articles via a three-dimensional printing (or 3D printing) process. In one implementation, a method of additive manufacturing is provided. The method comprises dispensing a first layer of a feed material over a platen. The feed material includes a powder mixture comprising a plurality of particulates comprising a first material and a plurality of particulates comprising a second material different from the first material. The method further comprises directing a laser beam to heat the feed material at locations specified by data stored in a computer readable medium. The laser beam heats the feed material to a temperature sufficient to fuse at least the second material.

In another implementation, a method of additive manufacturing is provided. The method comprises dispensing a first layer of a feed material over a platen. The feed material includes a powder mixture comprising particulates, each particulate having a core that is the first material coated with the second material. The method further comprises directing a laser beam to heat the feed material at locations specified by data stored in a computer readable medium. The laser beam heats the feed material to a temperature sufficient to fuse at least the second material.

In yet another implementation, a method of additive manufacturing is provided. The method comprises dispensing a first layer of feed material over a platen. The first layer of feed material includes a plurality of particulates comprising a first material having a melting or sintering temperature. The method further comprises dispensing a second layer of feed material over the first layer of feed material. The second layer of feed material includes a plurality of particulates comprising a second material having a melting or sintering temperature. The method further comprises directing a laser beam to heat the second layer of feed material at locations specified by data stored in a computer readable medium. The laser beam heats the second layer of feed material to a temperature sufficient to fuse at least the second material.

In yet another implementation, a method of additive manufacturing is provided. The method comprises laser sintering or laser melting a powder mixture in a selective laser sintering method or a selective laser melting method, wherein the powder mixture comprises particulates, each particulate having a core material coated with a coating material that is different from the core material, wherein the core material is selected from the group comprising ceramic materials, metal materials, metal alloys and plastic materials and the coating material is selected from the group comprising ceramic materials, metal materials, metal alloys, and plastic materials.

### BRIEF DESCRIPTION OF THE DRAWINGS

So that the manner in which the above-recited features of the present disclosure can be understood in detail, a more particular description of the implementations, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 is a schematic view of an exemplary additive manufacturing system that may be used to perform one or more implementations described herein;

FIG. 2 is a schematic view of a portion of a 3D-part formed according to one or more implementations described herein;

FIG. 3 is a flow chart depicting a method of forming a 3D-part according to implementations described herein;

FIG. 4 is a flow chart depicting another method of forming a 3D-part according to implementations described herein; and

FIG. 5 is a flow chart depicting yet another method of forming a 3D-part according to implementations described herein.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

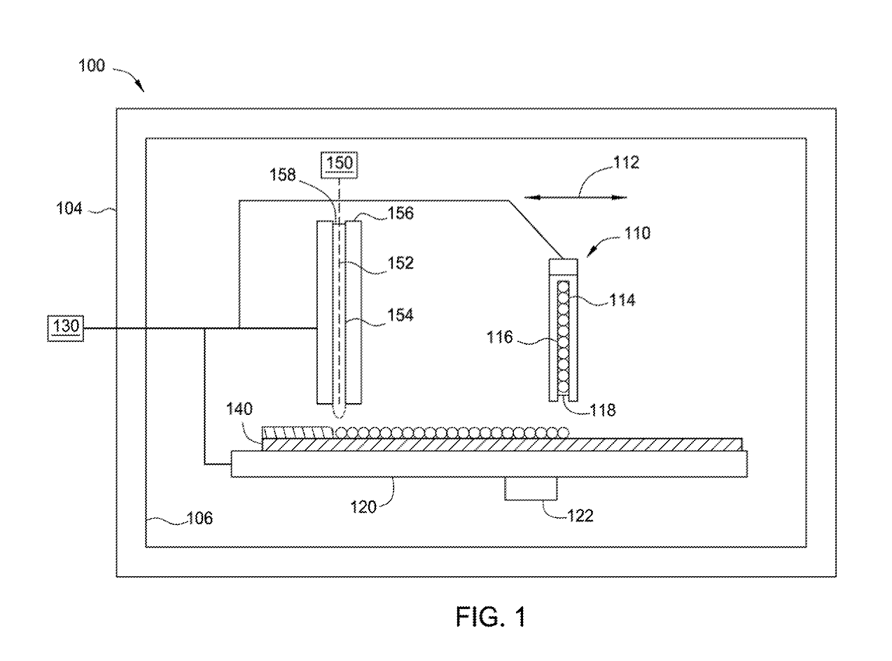

The following disclosure describes formulations and processes for forming articles via a three-dimensional printing (or 3D printing) process. Certain details are set forth in the following description and in FIGS. 1-5 to provide a thorough understanding of various implementations of the disclosure. Other details describing well-known structures and systems often associated with additive manufacturing processes are not set forth in the following disclosure to avoid unnecessarily obscuring the description of the various implementations.

Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Three-dimensional printing allows for the development of unique materials and microstructures. In 3D printing, materials are formed using an additive manufacturing process. Due to the nature of 3D printing technology, compositions can be fabricated using structures having differentiated properties at several length scales. The majority of commercially available 3D printed parts focus on form factor and geometrical features of the end article. Given the nature of the deposition enabled by 3D printing, it is possible to fabricate articles with chemical compositions, which are thermodynamically metastable, and microstructures (void fraction, crystallinity, grain size and orientation among other features) not feasible via currently available techniques.

Some implementations of the present disclosure include development of materials and deposition approaches leading to desired end properties (mechanical, electrical or thermal etc.) over length scales ranging from nanometers to millimeters. Materials developed according to the present disclosure include at least one of the following: (a) metallic, glassy, glass-ceramic, or polymeric compositions; (b) composites consisting of fibers, whiskers embedded in the second phase matrix (e.g., aluminum-silicon carbide composites); (c) catalytic materials having controlled open and closed porosity across the thickness; and (d) alloy compositions with ability to control the minor alloying element amount to 0.1 at %. After deposition, the deposited materials may be consolidated (sintered or densified) in-situ using a heat source (e.g., a laser, microwave, optical, or electrochemical source of energy).

In some implementations of the present disclosure, metallurgical phase diagrams, coating or plating, two phase mixtures, and metal-glassy or metal-glass-ceramic compositions are used to form 3D-parts. In some implementations, phase diagrams with low temperature eutectics are used. Exemplary compositions include Al-based alloys (e.g., with Zn, Cu, Mg, and Si as alloying elements).

In some implementations, highly conductive metallic materials (e.g., copper, silver, or gold) are plated on ceramic powder particles and sintered (e.g., fused) during 3D printing. This combination provides unique thermal and electrical properties of metals combined with the strength and hardness of ceramic materials. Another implementation includes coating low temperature glass compositions on metal powders followed by printing and fusion yielding electrically and thermally insulating structures.

In some implementations, processing of printed structures including controlled porosity (or voids) is accomplished by printing metal particles coated with an organic material. During high temperature fusion, also known as sintering or compaction, the organic materials burn-off leaving controlled voids between metal particles. These printed structures may be used as, for example, membranes, catalysts, and filters with unique thermal and electrical properties.

In some implementations, processing of printed structures, including controlled porosity (void fraction), crystallinity, and grain size and grain orientation is achieved by modifying the parameters of the laser source (e.g., power density, exposure time and pulse duration) used to achieve fusion.

In some implementations, additive manufacturing is used to form chamber articles or parts for semiconductor-manufacturing equipment, wherein the chamber article or part is formed from dissimilar materials. One such example is a chamber liner wherein the bulk material is aluminum or a stainless steel alloy (processed using 3D printing) coated with an outer disposable coating of another (chemically compatible) metal. During preventive maintenance, the outer disposable coating is bead blasted away along with deposited process residue. The outer disposable coating (e.g., ˜1 millimeter thick) can be 3D printed during a refurbishment process allowing reuse of the chamber hardware while avoiding the use of hazardous chemicals typically used in component cleaning.

FIG. 1 is a schematic view of an additive manufacturing system 100 that may be used to perform one or more implementations described herein. The additive manufacturing system description described herein is illustrative and should not be construed or interpreted as limiting the scope of the implementations described herein. The additive manufacturing system 100 can be, for example, a system for selective laser sintering (SLS), a system for selective laser melting (SLM), or a stereo lithography system. The additive manufacturing system 100 includes and is enclosed by a housing 104. The housing 104, for example, may allow a vacuum environment to be maintained inside the housing 104, but alternatively the interior of the housing 104 can be a substantially pure gas or mixture of gases, e.g., a gas or mixture of gases that has been filtered to remove particulates, or the housing can be vented to atmosphere. The vacuum environment or the filtered gas can reduce defects during manufacturing of a part. In some implementations, the housing 104 can be maintained at a positive pressure (i.e., above atmospheric pressure. This can help prevent the external atmosphere from entering the housing 104.

The additive manufacturing system 100 includes a dispenser assembly 110 to deliver a layer of powder over a platen 120, e.g., on the platen or onto an underlying layer on the platen.

A vertical position of the platen 120 can be controlled by a piston 122. After each layer of powder has been dispensed and fused, the piston 122 can lower the platen 120 and any layers of powder thereon, by the thickness of one layer, so that the assembly is ready to receive a new layer of powder.

The platen 120 can be sufficiently large to accommodate fabrication of large-scale industrial parts. For example, the platen 120 can be at least 500 mm across, e.g., 500 mm by 500 mm square. For example, the platen can be at least 1 meter across, e.g., 1 meter square.

In some implementations, the dispenser assembly 110 is positionable above the platen 120. The dispenser assembly 110 can include an opening through which a feed material 114 is delivered, e.g., by gravity, over the platen 120. For example, the dispenser assembly 110 can include a reservoir 116 to hold feed material 114. Release of the feed material 114 may be controlled by a gate 118. Electronic control signals are sent to the gate 118 to dispense the feed material when the dispenser is translated to a position specified by the CAD-compatible file.

The gate 118 of the dispenser assembly 110 can be provided by a piezoelectric printhead, and/or one or more of pneumatic valves, microelectromechanical systems (MEMS) valves, solenoid valves, or magnetic valves, to control the release of feed material from the dispenser assembly 110.

Alternatively, the dispenser assembly 110 can include a reservoir positioned adjacent the platen 120, and a roller that is moved horizontally (parallel to the surface of the platen) to push the feed material 114 from the reservoir and across the platen 120.

A controller 130 controls a drive system (not shown), e.g., a linear actuator, connected to the dispenser assembly 110 or roller. The drive system is configured such that, during operation, the dispenser assembly 110 or roller is movable back and forth parallel to the top surface of the platen 120 (along the direction of travel indicated by arrow 112). For example, the dispenser assembly 110 or roller can be supported on a rail that extends across the chamber 106. Alternatively, the dispenser assembly 110 or roller could be held in a fixed position, while the platen 120 is moved by the drive system.

In the implementation of a dispenser assembly 110 that includes an opening through which feed material is delivered, as the dispenser assembly 110 scans across the platen, the dispenser assembly 110 can deposit feed material at an appropriate location on the platen 120 according to a printing pattern that can be stored in non-transitory computer-readable medium. For example, the printing pattern can be stored as a file, e.g., a computer aided design (CAD)-compatible file, that is then read by a processor associated with the controller 130. Electronic control signals are then sent to the gate 118 to dispense the feed material when the dispenser is translated to a position specified by the CAD-compatible file.

In some implementations, the dispenser assembly 110 includes a plurality of openings through which feed material can be dispensed. Each opening can have an independently controllable gate, so that delivery of the feed material through each opening can be independently controlled.

In some implementations, the plurality of openings extend across the width of the platen 120, e.g., in direction perpendicular to the direction of travel indicated by arrow 112 of the dispenser assembly 110. In this implementation, in operation, the dispenser assembly 110 can scan across the platen 120 in a single sweep in the direction of travel indicated by arrow 112. In some implementations, for alternating layers the dispenser assembly 110 can scan across the platen 120 in alternating directions, e.g., a first sweep in the direction of travel indicated by arrow 112 and a second sweep in the opposite direction.

Alternatively, e.g., where the plurality of openings do not extend across the width of the platen, the dispensing system can be configured such that the dispenser assembly 110 moves in two directions to scan across the platen 120, e.g., a raster scan across the platen 120, to deliver the material for a layer.

Alternatively, the dispenser assembly 110 can simply deposit a uniform layer of feed material over the platen 120. In this implementation, neither independent control of individual openings nor a printing pattern stored in non-transitory computer-readable medium is needed.

Optionally, more than one feed material can be provided by the dispenser assembly 110. In such a implementation, each feed material can be stored in a separate reservoir having its own control gate and be individually controlled to release respective feed material at locations on the platen 120 as specified by the CAD file. In this way, two or more different chemical substances can be used to produce an additively manufactured part.

The feed material 114 can be dry powders of metallic, plastic and/or ceramic particles, metallic or ceramic powders in liquid suspension, or a slurry suspension of a material. For example, for a dispenser that uses a piezoelectric printhead, the feed material would typically be particles in a liquid suspension. For example, the dispenser assembly 110 can deliver powder in a carrier fluid, for example, a high vapor pressure carrier, e.g., Isopropyl Alcohol (IPA), ethanol, or N-Methyl-2-pyrrolidone (NMP), to form the layers of powder material. The carrier fluid can evaporate prior to the sintering process for the layer. Alternatively, a dry dispensing mechanism, e.g., an array of nozzles assisted by ultrasonic agitation and pressurized inert gas, can be employed to dispense the particles.

Examples of metallic particles that may be used with implementations described herein include metals, alloys and intermetallic alloys. Examples of materials for the metallic particles that may be used with the implementations described herein include aluminum (Al), gold (Au), silver (Ag), nickel (Ni), iron (Fe), copper (Cu), chromium (Cr), cobalt (Co), magnesium (Mg), tungsten (W), titanium (Ti), tantalum (Ta), molybdenum (Mo), vanadium (V), stainless steel, and various alloys or intermetallic alloys of these metals. Examples of ceramic materials that may be used with the implementations described herein include metal oxides, such as ceria, alumina, silica, magnesium oxide, aluminum nitride, silicon nitride, silicon carbide, or a combination of these materials. Exemplary plastic materials that may be used with the implementations described herein include nylon, acrylonitrile butadiene styrene (ABS), polyurethane, acrylate, epoxy, polyetherimide, polyetheretherketone (PEEK), polyetherketoneketone (PEKK), polystyrene or polyamides.

Optionally, the additive manufacturing system 100 can include a compaction and/or leveling mechanism to compact and/or smooth the layer of feed materials deposited over the platen 120. For example, the system can include a roller or blade that is movable parallel to the platen surface by a drive system, e.g., a linear actuator. The height of the roller or blade relative to the platen 120 is set to compact and/or smooth the outermost layer of the feed material 114. The roller can rotate as it translates across the platen.

During manufacturing, layers of feed materials are progressively deposited and sintered or melted. For example, the feed material 114 is dispensed from the dispenser assembly 110 to form a layer 140 that contacts the platen 120. Subsequently deposited layers of the feed material 114 can form additional layers, each of which is supported on an underlying layer.

After each layer is deposited, the outermost layer is processed to cause at least some of the layer to fuse, e.g., by sintering or by melting and resolidifying. Regions of feed material that are not fused in a layer can serve to support portions of an overlying layer.

The additive manufacturing system 100 includes a heat source configured to supply sufficient heat to the layer of the feed material 114 to cause the powder to fuse. Where the feed material 114 is dispensed in a pattern, the heat source can heat the entire layer simultaneously. Alternatively, if the feed material 114 is deposited uniformly on the platen 120, the heat source can be configured to heat locations specified by a printing pattern stored in a computer-readable medium, e.g., as a computer aided design (CAD)-compatible file, to cause fusing of the powder at the locations. Any suitable heat source that sufficiently heats the feed material 114 may be used. Examples of heat sources include laser sources, microwave sources, or electrochemical sources of energy.

In some implementations, the heat source is a laser source 150 which generate a laser beam 152. The laser beam 152 emitted from the laser source 150 is directed to locations specified by the printing pattern. For example, the laser beam 152 is raster scanned across the platen 120, with laser power being controlled at each location to determine whether a particular voxel fuses or not. The laser beam 152 can also scan across locations specified by the CAD file to selectively fuse the feed material at those locations. To provide scanning of the laser beam 152 across the platen 120, the platen 120 can remain stationary while the laser beam 152 is horizontally displaced. Alternatively, the laser beam 152 can remain stationary while the platen 120 is horizontally displaced.

The laser beam 152 from the laser source 150 is configured to raise the temperature of a region of the feed material 114 that is irradiated by the laser beam 152 to a temperature sufficient to fuse the feed material 114. In some implementations, the region of the feed material 114 is positioned directly below the laser beam 152.

The platen 120 can additionally be heated by a heater, e.g., by a heater embedded in the platen 120, to a base temperature that is below the fusing point of the feed material 114. In this way, the laser beam 152 can be configured to provide a smaller temperature increase to fuse the deposited feed material 114. Transitioning through a small temperature difference can enable the feed material 114 to be processed more quickly. For example, the base temperature of the platen 120 can be about 1500 degrees Celsius and the laser beam 152 can cause a temperature increase of about 50 degrees Celsius.

The laser source 150 can undergo motion relative to the platen 120, or the laser can be deflected, for example, by a mirror galvanometer. The laser beam 152 can generate sufficient heat to cause the feed material 114 to fuse. The laser source 150 and/or the platen 120 can be coupled to an actuator assembly, for example, a pair of linear actuators configured to provide motion in perpendicular directions to provide relative motion between the laser source 150 and the platen 120. The controller 130 can be connected to the actuator assembly to cause the laser beam 152 to be scanned across the layer of feed material 114.

The laser source 150 can include a conduit 154, for example, a tube through which the laser beam 152 propagates. The laser beam 152 can propagate through the conduit 154 toward a surface of the platen 120. An end 156 of the conduit 154 that is farthest from the platen 120 may be terminated by a window 158 that is transparent to a wavelength of laser beam 152. The laser beam 152 can propagate from the laser source 150 through the window 158 into the conduit 154.

The end of the conduit 154 closest to the platen 120 can be open or can be closed except for an aperture that would permit the laser beam 152 to pass through toward the platen 120. The resolution of the laser source 150 may be millimeters, down to microns. In other words, chemical reactions of the feed material can be localized to a few millimeters of the additively manufactured part, thus providing excellent spatial control of the physical properties of the manufactured part.

In some implementations, the controller 130 can be used to control the parameters of the laser source 150, for example, power density and pulse density, to adjust the heat delivered to the feed material 114. The adjustments can be made in conjunction with a position (x-y position) of the laser beam on a particular layer (z-position) of feed material. In this way, the desired physical properties (e.g., void fraction, crystallinity, grain size and orientation) of the fabricated part can vary as a function of lateral (x-y) position within a particular feed layer.

In operation, after each layer has been deposited and heat-treated, the platen 120 is lowered by an amount substantially equal to the thickness of layer. Then the dispenser assembly 110, which does not need to be translated in the vertical direction, scans horizontally across the platen to deposit a new layer that overlays the previously deposited layer and the new layer can then be heat-treated to fuse the feed material. This process can be repeated until the full 3-dimensional object is fabricated. The fused feed material derived by heat treatment of the feed material provides the additively manufactured object.

In one implementation, the dispenser assembly 110 is a single point dispenser, and the dispenser assembly 110 is translated across the x and y direction of the platen 120 to deposit a complete layer of feed material 114 on the platen 120.

In another implementation, the dispenser assembly 110 is a line dispenser that extends across the width of the platen 120. For example, the dispenser assembly 110 includes a linear array of individually controllable openings, e.g., nozzles. The dispenser assembly 110 can be translated only along one dimension, e.g., substantially perpendicular to the long axis of the dispenser assembly 110, to deposit a complete layer of feed material 114 on the platen 120.

The dispenser assembly 110 can be used to deposit feed material 114 onto or over the platen 120. The controller 130 similarly controls a drive system (not shown), e.g., a linear actuator, connected to the dispenser assembly 110. The drive system is configured such that, during operation, the dispenser assembly 110 is movable back and forth parallel to the top surface of the platen 120.

Referring to FIG. 1, the controller 130 of the additive manufacturing system 100 is connected to the various components of the system, e.g., actuators, valves, and voltage sources, to generate signals to those components, coordinate the operation and cause the system to carry out the various functional operations or sequence of operations described above. The controller can be implemented in digital electronic circuitry, or in computer software, firmware, or hardware. For example, the controller can include a processor to execute a computer program as stored in a computer program product, e.g., in a non-transitory machine-readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

As noted above, the controller 130 can include non-transitory computer readable medium to store a data object, e.g., a computer aided design (CAD)-compatible file that identifies the pattern in which the feed material 114 should be deposited for each layer. For example, the data object could be a STL-formatted file, a 3D Manufacturing Format (3MF) file, or an Additive Manufacturing File Format (AMF) file. For example, the controller 130 could receive the data object from a remote computer. A processor in the controller 130, e.g., as controlled by firmware or software, can interpret the data object received from the computer to generate the set of signals necessary to control the components of the system to print the specified pattern for each layer.

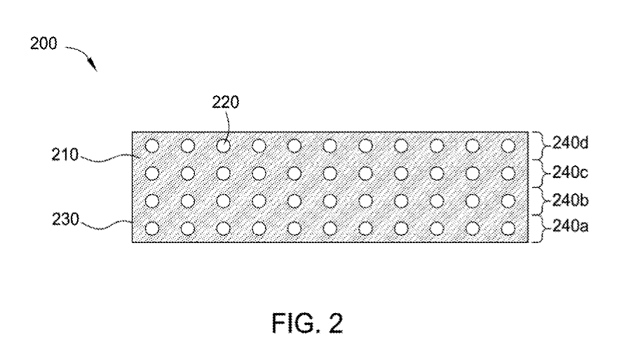

FIG. 2 is a schematic view of a portion of a 3D-part 200 formed according to one or more implementations described herein. The 3D-part comprises a composite material 210. The composite material 210 includes an inner core material 220 (“Phase A”) embedded in a matrix material 230 (Phase B). Exemplary materials that may be used for Phase A and Phase B are depicted in Table 1 as follows:

TABLE I

| | Example 1 | Example 2 | Example 3 | Example 4 |
|---|---|---|---|---|
| Phase A | Metal | Ceramic | Metal | Metal 1 |
| Phase B | Ceramic | Metal | Organic | Metal 2 |

The composite material 210 may be deposited as a series of subsequent layers of feed material that are cured for form the 3D-part 200. For example, 3D-part 200 is formed by deposition of four layers 240a-d that are deposited and subsequently cured according to method 300 described below. In some implementations, each layer 240a-d is formed by depositing a powder mixture containing particles of the Phase A material and particles of the Phase B material. In some implementations, each layer 240a-d is formed by depositing a powder mixture including particles that contain the Phase A material coated with the Phase B material. In some implementations, each layer 240a-d is formed by depositing a powder mixture including particles that contain the Phase B material coated with the Phase A material. In some implementations, each layer 240a-d is formed by depositing a powder mixture including particles that contains either the Phase A material or the Phase B material. The deposited particles are exposed to a fusing process (e.g., laser sintering or laser melting). During the fusing process, heating the Phase B material forms the matrix material 230.

FIG. 2 illustrates one example of the 3D-part 200. It should be understood, however, that subsequently formed layers 240b, 240c, and 240d may have any desirable shape or thickness and may be the same as or different from any other layer 240a, 240b, 240c, and 240d depending upon the size, shape, etc. of the 3D-part 200 that is to be formed. It should also be understood that the four layers of 3D-part 200 are only exemplary and that the 3D-part may comprise any number of layers.

Since at least some of the feed material remains uncured after each layer 240a, 240b, 240c, 240d is formed; the 3D-part 200 is at least partially surrounded by the uncured feed material on the platen. When the 3D-part 200 is complete, it may be removed from the platen, and the uncured feed material remaining on the platen may be reused. The 3D-part 200 may be treated with water or other solvents in order to remove any uncured feed material remaining on the surface of the 3D-part 200.

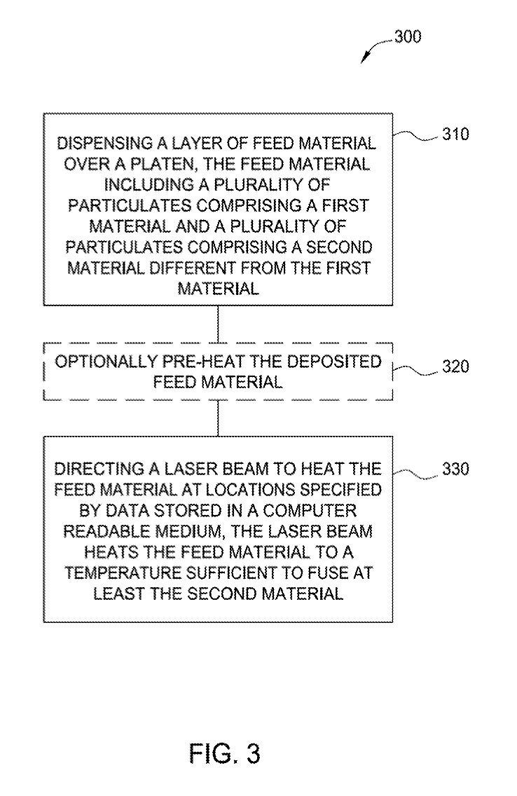

FIG. 3 is a flow chart depicting a method 300 of forming a 3D-part according to implementations described herein. In one implementation, the 3D-part formed using the method 300 is 3D-part 200 depicted in FIG. 2.

At operation 310, a layer of feed material is dispensed over a platen. In some implementations, the feed material is the feed material 114 and the platen is platen 120. In some implementations, the feed material may be dispensed using dispenser assembly 110. The feed material includes at least a first material and a second material, wherein the first material is different from the second material. In one implementation, the feed material includes two or more materials having different melting temperatures, sintering temperatures or both melting and sintering temperatures. At least one of the two or more materials is a sinterable material. In some implementations, the feed material includes a first material having a first melting and/or sintering temperature and a second material having a second melting and/or sintering temperature less than the first melting and/or sintering temperature. In some implementations, the first material is selected from the group of ceramic materials, metallic materials, metal alloy materials, and plastic materials and the second material is selected from the group of ceramic materials, metallic materials, metal alloy materials, and plastic materials. The first material and the second material may be selected as shown in Table 1. Referring to FIG. 2, the first material is the inner core material 220 and the second material forms the matrix material 230.

In one implementation, the feed material includes a powder mixture comprising particulates. In one implementation, the powder mixture comprises non-metallic particulates and metallic particulates. The particulates can independently have a diameter that is between about 10 to about 300 micrometers (e.g., between about 10 to about 200 micrometers; between about 50 to about 150 micrometers; or between about 50 to about 100 micrometers).

Exemplary metallic materials that may be used with the implementations described herein include aluminum (Al), gold (Au), silver (Ag), nickel (Ni), iron (Fe), copper (Cu), chromium (Cr), cobalt (Co), magnesium (Mg), tungsten (W), titanium (Ti), tantalum (Ta), molybdenum (Mo), vanadium (V), stainless steel, and various alloys or intermetallic alloys of these metals.

Exemplary ceramic materials that may be used with the implementations described herein include metal oxide, such as ceria, alumina, silica, magnesium oxide, aluminum nitride, silicon nitride, silicon carbide, or a combination of these materials.

Exemplary plastic materials that may be used with the implementations described herein include nylon, acrylonitrile butadiene styrene (ABS), polyurethane, acrylate, epoxy, polyetherimide, polyetheretherketone (PEEK), polyetherketoneketone (PEKK), polystyrene or polyamides.

In one implementation, the first material is a metal and the second material is a metal. For example, the first material is copper and the second material is gold. In one implementation, gold is plated on a copper core.

In one implementation, the first material is a ceramic and the second material is a metal. For example, the first material is alumina (Al₂O₃) and the second material is gold, copper, aluminum, magnesium or zinc. In one implementation, gold, copper, aluminum, magnesium or zinc is plated on an alumina core.

In one implementation, the first material is metal and the second material is plastic.

Optionally, at operation 320, the feed material is pre-heated prior to exposure to the laser beam in operation 330. Heating is performed to pre-heat the feed material. The feed material is typically pre-heated to a temperature below the melting point of the sinterable material (e.g., below the melting point of the material with the lower melting point). As such, the temperature selected will depend upon the sinterable material used. As examples, the heating temperature may be from about 5 to 50 degrees Celsius below the melting point of the sinterable material that is used. In one implementation, the heating temperature may be from about 50 degrees Celsius to about 350 degrees Celsius. In another example, the heating temperature ranges from about 60 degrees Celsius to about 170 degrees Celsius.

Pre-heating the feed material 114 may be accomplished by any suitable heat source that exposes the feed material 114 on the platen 120 to the heat. Examples of the heat source include a thermal heat source or a light radiation source. In one implementation, the thermal heat source is embedded in the platen 120.

At operation 330, a laser beam is directed at locations of the feed material to heat the feed material. The locations are specified by data stored in a computer readable medium. In some implementations, the laser beam heats the feed material to a temperature sufficient to fuse at least the second material. In some implementations, the laser beam heats the feed material to a temperature sufficient to fuse at least the second material while at least some of the first material remains unfused. In some implementations, the laser beam heats the feed material to a temperature greater than or equal to the second melting and/or sintering temperature, allowing fusing (e.g., sintering, binding, curing, etc.) of the feed material.

The parameters of the laser source (e.g., power density, exposure time and pulse duration) used to achieve fusion may be modified in order to achieve desired properties including controlled porosity (void fraction), crystallinity, grain size and grain orientation in the 3D-part. For example, the length of time that the laser is applied for, or energy exposure time, may be dependent, for example on one or more of: characteristics of the laser source, characteristics of the feed material, and/or the desired end properties of the 3D-part.

In one implementation, the laser beam is pulsed during operation 330.

It is to be understood that variations in the fusing level and corresponding properties (e.g., void fraction, porosity, etc.) may be achieved by varying at least one of the exposure time, pulse duration, power level, or power density. As an example, if it is desirable that the level of fusing decrease along the Z-axis, the radiation exposure time may be highest in the first layer and decrease in subsequently formed layers.

As the layers of the 3D-part are built-up in the Z-direction, uniformity or variations in properties may be achieved along the XY plane and/or along the Z-axis. As an example, if it is desirable that the amount of voids in the structure increase along the Z-axis, the radiation applied may be highest in the first layer and decrease in subsequently formed layers.

As mentioned above, exposure to radiation from the laser beam cures the lower melting and/or sintering temperature material to form the layer 240a of the 3D-part 200. It is to be understood that heat absorbed during the application of energy from a portion of the feed material may propagate to a previously solidified layer, such as the layer 240a, causing at least some of the layer to heat up above its melting or sintering point, which helps create strong interlayer bonding between adjacent layers of the 3D-part 200.

Operations 310-330 may be repeated as many times to create subsequent layers 240b, 240c, and 240d (FIG. 2) and to form the 3D-part 200. For example, operation 310 may be repeated to dispense a second layer of the feed material over the first layer of the feed material. Operation 330 may be repeated to direct the laser beam to heat the second layer of the feed material at locations specified by data stored in a computer readable medium. At least one parameter of the laser beam selected from exposure time, pulse duration, power level, and power density of the laser beam may be varied while directing the laser beam to heat the second layer. The at least one parameter is varied relative to the parameters used during deposition of prior layers of feed material.

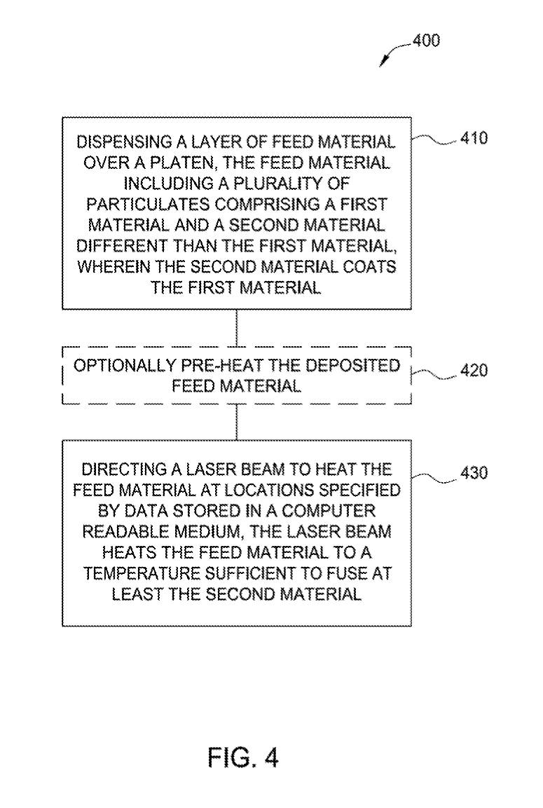

FIG. 4 is a flow chart depicting a method 400 of forming a 3D-part according to implementations described herein. In one implementation, the 3D-part formed using the method 400 is 3D-part 200 depicted in FIG. 2. The method 400 is similar to method 300 except that the particulates comprise a first core material and a second coating material different from the first core material. In some implementations, the first core material has a first melting and/or sintering temperature and the second material has a second melting and/or sintering temperature, wherein the second melting and/or sintering temperature is less than the first melting and/or sintering temperature.

At operation 410, a layer of feed material is dispensed over a platen. In some implementations, the feed material is the feed material 114 and the platen is platen 120. In some implementations, the feed material may be dispensed using dispenser assembly 110. The feed material includes a plurality of particulates comprising a first core material and a second coating material that is different from the first core material, wherein the second coating material is coated on the first core material. In some implementations, the feed material includes a plurality of particulates comprising at least a first core material having a first melting and/or sintering temperature and a second material having a second melting and/or sintering temperature, wherein the second melting and/or sintering temperature is less than the first melting and/or sintering temperature and the second material coats the first material. At least one of the two or more materials is a sinterable material. In some implementations, the first material is selected from the group of ceramic materials, metallic materials, metal alloy materials, plastic materials and the second material is selected from the group of ceramic materials, metallic materials, metal alloy materials, and plastic materials. The first material, which is Phase A, and the second material, which forms Phase B, may be selected as shown in Table 1. Referring to FIG. 2, the first material is the inner core material 220 and the second material forms the matrix material 230.

The particulates can independently have a diameter that is about 10 to 300 micrometers (e.g., about 10 to 200 micrometers; about 50 to 150 micrometers; or about 50 to 100 micrometers). The first material that forms the core can have a diameter that is, for example, about 10 to 300 micrometers (e.g., about 10 to 200 micrometers; about 50 to 150 micrometers; or about 50 to 100 micrometers) and the second material that forms the coating or shell can have a thickness of, for example, about 3 to 500 nanometers (e.g., about 100 to 500 nanometers; about 3 to 50 nanometers; or about 50 to 100 nanometers).

In one implementation, the first material is a metal and the second material is a metal. For example, the first material is gold plated on a copper core.

In one implementation, the first material is a ceramic and the second material is a metal. For example, in one implementation, gold, copper, aluminum, magnesium or zinc is plated on an alumina core.

In one implementation, the first material is metal and the second material is plastic. For example, in one implementation, plastic is coated on a metallic material.

Optionally, at operation 420, the feed material is pre-heated prior to exposure to the laser beam in operation 430. Heating is performed to pre-heat the feed material. The feed material is typically pre-heated to a temperature below the melting point of the sinterable material (e.g., below the melting point of the material with the lower melting point). As such, the temperature selected will depend upon the sinterable material used. As examples, the heating temperature may be from about 5 to 50 degrees Celsius below the melting point of the sinterable material that is used. In one implementation, the heating temperature may be from about 50 degrees Celsius to about 350 degrees Celsius. In another example, the heating temperature ranges from about 60 degrees Celsius to about 170 degrees Celsius.

Pre-heating the feed material 114 may be accomplished by any suitable heat source that exposes the feed material 114 on the platen 120 to the heat. Examples of the heat source include a thermal heat source or a light radiation source. In one implementation, the thermal heat source is embedded in the platen 120.

At operation 430, a laser beam is directed at locations of the feed material to heat the feed material. The locations are specified by data stored in a computer readable medium. In some implementations, the laser beam heats the feed material to a temperature sufficient to fuse at least the second material. In some implementations, the laser beam heats the feed material to a temperature sufficient to fuse at least the second material while at least some of the first material remains unfused. In some implementations, the laser beam heats the feed material to a temperature greater than or equal to the second melting and/or sintering temperature, allowing fusing (e.g., sintering, binding, curing, etc.) of the feed material. Operation 430 may be performed similarly to operation 330 of method 300.

As mentioned at operation 330, the parameters of the laser source (e.g., power density, exposure time, pulse duration, etc.) used to achieve fusion during operation 430 may be modified in order to achieve desired properties including controlled porosity (void fraction), crystallinity, grain size and grain orientation in the 3D-part.

As mentioned above, exposure to radiation from the laser beam fuses at least the feed material that melts and or sinters at the lower melting and/or sintering temperature to form the layer 240a of the 3D-part 200. It is to be understood that heat absorbed during the application of energy from a portion of the feed material may propagate to a previously solidified layer, such as the layer 240a, causing at least some of the layer to heat up above its melting or sintering point, which helps create strong interlayer bonding between adjacent layers of the 3D-part 200.

Operations 410-430 may be repeated as many times to create subsequent layers 240b, 240c, and 240d (FIG. 2) and to form the 3D-part 200. For example, operation 410 may be repeated to dispense a second layer of the feed material over the first layer of the feed material. Operation 430 may be repeated to direct the laser beam to heat the second layer of the feed material at locations specified by data stored in a computer readable medium. At least one parameter of the laser beam selected from exposure time, pulse duration, power level, and power density of the laser beam may be varied while directing the laser beam to heat the second layer. The at least one parameter is varied relative to the parameters used during deposition of prior layers of feed material.

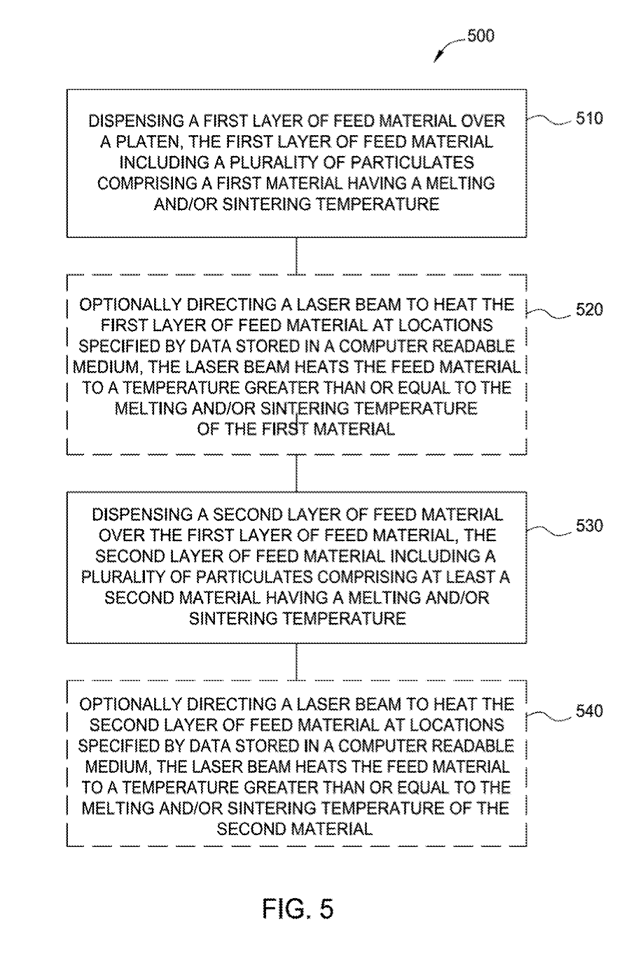

FIG. 5 is a flow chart depicting a method 500 of forming a 3D-part according to implementations described herein. In one implementation, the 3D-part formed using the method 500 is 3D-part 200 depicted in FIG. 2. The method 500 is similar to method 300 except that the particulates comprising the first material and the particulates comprising the second material are deposited in separate layers.

At operation 510, a first layer of feed material is dispensed over a platen. In some implementations, the feed material is feed material 114 and the platen is platen 120. In some implementations, the feed material may be dispensed using dispenser assembly 110. The feed material includes a plurality of particulates comprising at least a first material having a first melting and/or sintering temperature. In some implementations, the first material is selected from the group of ceramic materials, metallic materials, metal alloy materials, and plastic materials.

The particulates can have a diameter that is about 10 to 300 micrometers (e.g., about 10 to 200 micrometers; about 50 to 150 micrometers; or about 50 to 100 micrometers).

Optionally, at operation 520, a laser beam is directed at the first layer of feed material at locations specified by data stored in a computer readable medium, the laser beam heats the feed material to a temperature greater than or equal to the first melting and/or sintering temperature.

At operation 530, a second layer of feed material is dispensed on the first layer of feed material. The second layer of feed material includes a plurality of particulates comprising at least a second material having a second melting and/or sintering temperature. In some implementations, the second melting and/or sintering temperature is less than the first melting and/or sintering temperature. In other implementations, the first melting and/or sintering temperature is greater than the second melting point.

At operation 540, a laser beam is directed to heat the second layer of feed material at locations specified by data stored in a computer readable medium, the laser beam heats the second layer of feed material to a temperature greater than or equal to the second melting and/or sintering temperature. At least one of the two or more materials is a sinterable material. In some implementations, the first material is selected from the group of ceramic materials, metallic materials, metal alloy materials, plastic materials and the second material is selected from the group of ceramic materials, metallic materials, metal alloy materials, and plastic materials. The first material, which is Phase A, and the second material, which forms Phase B, may be selected as shown in Table 1. Referring to FIG. 2, the first material is the inner core material 220 and the second material forms the matrix material 230.

As mentioned at operation 330, the parameters of the laser source (e.g., power density, exposure time, pulse duration, etc.) used to achieve fusion during operations 520 and 540 may be modified in order to achieve desired properties including controlled porosity (void fraction), crystallinity, grain size and grain orientation in the 3D-part.

As mentioned above, exposure to radiation from the laser beam cures the lower melting and/or sintering temperature feed material to form the matrix portion of the layer 240a of the 3D-part 200. Operations 510-540 may be repeated as many times to create subsequent layers 240b, 240c, and 240d (FIG. 2) and to form the 3D-part 200. It is to be understood that heat absorbed during the application of energy from a portion of the feed material may propagate to a previously solidified layer, such as the layer 240a, causing at least some of the layer to heat up above its melting or sintering point, which helps create strong interlayer bonding between adjacent layers of the 3D-part 200.

In summary some of the benefits of some implementations of the present disclosure include the ability to fabricate parts 3D-parts using structures having differentiated properties at several length scales. Currently available 3D printed parts focus on form factor and geometrical features of the end article. In contrast, using the implementations described herein it is possible to fabricate articles with chemical compositions, which are thermodynamically metastable, and microstructures (void fraction, crystallinity, grain size and orientation among other features) not feasible via currently available techniques.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to implementations of the present invention, other and further implementations of the present disclosure may be devised without departing from the basic scope thereof, and the scope thereof is determined by the claims that follow.

1. A method of additive manufacturing, comprising:
dispensing a first layer of a feed material over a platen, wherein the feed material includes a powder mixture comprising a plurality of particulates comprising a first material and a plurality of particulates comprising a second material different than the first material; and
directing a laser beam to heat the feed material at locations specified by data stored in a computer readable medium, wherein the laser beam heats the feed material to a temperature sufficient to fuse at least the second material.

2. The method of claim 1, wherein the temperature is greater than or equal to a melting or sintering temperature of the second material but less than the melting or sintering temperature of the first material.

3. The method of claim 1, wherein the particulates have a diameter that is between about 10 to about 300 micrometers.

4. The method of claim 1, wherein the first material is non-metallic and the second material is metallic.

5. The method of claim 1, wherein at least a portion of the first material remains unfused during the directing the laser beam to heat the feed material.

6. The method of claim 1, further comprising:
dispensing a second layer of the feed material over the first layer of the feed material; and
directing the laser beam to heat the second layer of the feed material at locations specified by data stored in a computer readable medium, wherein the laser beam heats the feed material while varying at least one parameter of the laser beam selected from exposure time, pulse duration, power level, and power density of the laser beam.

7. The method of claim 1, wherein the first material is selected from the group of ceramic materials, metallic materials, metal alloy materials, and plastic materials and the second material is selected from the group of ceramic materials, metallic materials, metal alloys, and plastic materials.

8. A method of additive manufacturing, comprising:
dispensing a first layer of a feed material over a platen, wherein the feed material includes a powder mixture comprising particulates, each particulate having a core that is the first material coated with the second material; and
directing a laser beam to heat the feed material at locations specified by data stored in a computer readable medium, wherein the laser beam heats the feed material to a temperature sufficient to fuse at least the second material.

9. The method of claim 8, wherein the temperature is greater than or equal to a melting or sintering temperature of the second material but less than the melting or sintering temperature of the first material.

10. The method of claim 8, wherein the particulates have a diameter that is between about 10 to about 300 micrometers.

11. The method of claim 8, wherein the first material is selected from the group of ceramic materials, metallic materials, metal alloy materials, and plastic materials and the second material is selected from the group of ceramic materials, metallic materials, metal alloys, and plastic materials.

12. The method of claim 8, wherein the first material is copper and the second material is gold.

13. The method of claim 8, wherein the first material is aluminum oxide (Al₂O₃) and the second material is gold, copper, aluminum, magnesium or zinc.

14. The method of claim 8, wherein at least a portion of the first material remains unfused during the directing the laser beam to heat the feed material.

15. The method of claim 8, further comprising:
dispensing a second layer of the feed material over the first layer of the feed material; and
directing the laser beam to heat the second layer of the feed material at locations specified by data stored in a computer readable medium, wherein the laser beam heats the feed material while varying at least one parameter of the laser beam selected from exposure time, pulse duration, power level, and power density of the laser beam.

16. A method of additive manufacturing, comprising:
dispensing a first layer of feed material over a platen, wherein the first layer of feed material includes a plurality of particulates comprising a first material having a melting or sintering temperature;
dispensing a second layer of feed material over the first layer of feed material, wherein the second layer of feed material includes a plurality of particulates comprising a second material having a melting or sintering temperature; and
directing a laser beam to heat the second layer of feed material at locations specified by data stored in a computer readable medium, wherein the laser beam heats the second layer of feed material to a temperature sufficient to fuse at least the second material.

17. The method of claim 16, wherein the temperature is greater than or equal to the melting or sintering temperature of the second material but less than the melting or sintering temperature of the first material.

18. The method of claim 16, wherein the particulates have a diameter that is between about 10 to about 300 micrometers.

19. The method of claim 16, wherein the first material is selected from the group of ceramic materials, metallic materials, metal alloy materials, and plastic materials and the second material is selected from the group of ceramic materials, metallic materials, metal alloys, and plastic materials.

20. The method of claim 16, wherein at least a portion of the first material remains unfused during the directing the laser beam to heat the second layer of the feed material.
